(19) United States
(12) Patent Application Publication
(10) Pub. No.: US 2015/0217223 A1
(43) Pub. Date: Aug. 6, 2015

(54) PROCESS FOR REGENERATING A SCRUBBING LIQUID WHICH IS PROVIDED FOR A GAS SCRUB AND IS ENRICHED IN AROMATIC HYCROCARBONS AND ALSO REGENERATION ARRANGEMENT

(71) Applicant: THYSSENKRUPP INDUSTRIAL SOLUTIONS AG, Essen (DE)

(72) Inventors: Diethmar Richter, Dortmund (DE); Holger Thielert, Dortmund (DE)

(73) Assignee: THYSSENKRUPP INDUSTRIAL SOLUTIONS AG, Essen (DE)

(21) Appl. No.: 14/420,659

(22) PCT Filed: Jul. 11, 2013
(86) PCT No.: PCT/EP2013/064715

§ 371 Date: Feb. 9, 2015

(30) Foreign Application Priority Data
Aug. 9, 2012 (DE) 102012107333.3

(51) Int. Cl. B01D 53/14

(52) U.S. Cl. CPC B01D 53/1425; B01D 53/1487; B01D 53/1493; B01D 2257/7027

(57) ABSTRACT

The invention relates to a process for regenerating a scrubbing liquid which is provided for a gas scrub and is enriched in aromatic hydrocarbons in a regeneration column, wherein the scrubbing liquid enriched in aromatic hydrocarbons is brought into contact with steam in a first regeneration stage of the regeneration column and the aromatic hydrocarbons are thereby partly removed from the scrubbing liquid, the scrubbing liquid purified in the first regeneration stage is divided into a first stream and a second stream, the second stream is discharged as purified scrubbing liquid for the gas scrub, the first stream is, for the purpose of further regeneration, fed to a second regeneration stage of the regeneration column in which the concentration of aromatic hydrocarbons is reduced compared to the concentration in the second stream by contact with steam, a stream of steam is firstly conveyed through the second regeneration stage and subsequently through the first regeneration stage and the first stream is discharged as more highly stripped scrubbing liquid for the gas scrub.

The invention relates to a process for regenerating a scrubbing liquid which is provided for a gas scrub and is enriched with aromatic hydrocarbons in a regeneration column. In the case of useful gases and offgases, there is frequently a need to remove impurities and interfering constituents of the gas in order to increase the purity of the gas, avoid environmental pollution or prevent fouling. In addition, substances scrubbed out from a process gas or offgas can sometimes also be passed to utilization in terms of material, which is why the economic aspects of a gas scrub also have to be taken into account.

For example, aromatic hydrocarbons are liberated as constituent of the coke oven gas formed in the coking of coal. To be able to pass the aromatic hydrocarbons to a further use and not release them into the environment, they are usually scrubbed out of the coke oven gas after the removal of tar and ammonia in the work-up of the coke oven gas. In practice, a scrubbing oil based on a tar oil fraction produced in the processing of hard coal is used as scrubbing liquid. Due to the main aromatic hydrocarbons present, viz. benzene, toluene, m-, p-, o-xylene and ethylbenzene, this process step is generally also referred to as BTEX scrub, BTX scrub or benzene scrub. The aromatic hydrocarbons mentioned are collectively also referred to as crude benzene, with the proportion of crude benzene typically being in the range from 20 to 40 gram per standard cubic meter (standard m³), depending on the coal used for the coking process and the process conditions. The crude benzene typically comprises from 55 to 75% of benzene, from 13 to 19% of toluene and from 5 to 10% of xylenes. The coke oven gas additionally contains polycyclic aromatic hydrocarbons, in particular naphthalene, which can be taken up by the scrubbing oil to a certain extent. Furthermore, the coke oven gas contains impurities, in particular H₂S, HCN, NH₃ and organic sulfur compounds. A typical composition of a coke oven gas comprises, for example:
from 54 to 62% by volume of H₂
from 23 to 28% by volume of CH₄
from 6.2 to 8% by volume of CO
H₂S about 7 g/standard m³
HCN about 1.5 g/standard m³
NH₃ 7 g/standard m³
S_{ORG} about 0.5 g/standard m³
BTX up to 40 g/standard m³
naphthalene up to 2 g/standard m³

BTEX scrubbing processes have been used without changes in their basic principles for decades and are described, for example, in the specialist textbook O. Grosskinsky, “Handbuch des Kokereiwesens”, Volume 2, 1958 edition, pages 137 ff. The BTEX scrub is carried out in one or more scrubbers arranged in series, with intimate contact between the coke oven gas and the scrubbing oil as scrubbing liquid having to be ensured to effect absorption of the aromatic hydrocarbons by the scrubbing oil. Intimate contact can be achieved either by means of fine atomization of the scrubbing oil or by means of thin oil films.

The combination of a sprinkling device with trays, packing elements or other internals, with the oil droplets coming from the sprinkling unit being spread out to form an oil film having a very large surface area, is particularly advantageous. The solubility of benzene, toluene and xylene is, in particular, dependent on the vapor pressure of the various components, for which reason the scrubbing oil is fed at comparatively low temperatures to the scrubber.

On the other hand, the scrubbing oil also has to have a sufficient flowability and low viscosity for it to be able to be distributed readily and be able to form a large surface area. The scrubbing oil enriched in aromatic hydrocarbons which collects at the bottom of the scrubber is taken off, and the crude benzene is subsequently driven off from the scrubbing oil at elevated temperature by stripping with steam. The scrubbing oil is then, after cooling, recirculated to the scrubber. In order to achieve substantial scrubbing-out of crude benzene at a very high throughput of coke oven gas, the scrubbing oil is introduced in excess into the scrubber. In order to be able to carry out the BTEX scrub at the amounts of coke oven gas obtained in modern coking plants, large amounts of scrubbing oil are required.

In order to improve the absorption of aromatic hydrocarbons from coke oven gas in a BTEX scrub, WO 2009/003 644 A1 proposes the use of biodiesel as scrubbing liquid. The term “biodiesel” refers to an organic fuel which, in contrast to fossil diesel oil, is not obtained from fossil crude oil but instead from vegetable oils by transesterification.

Biodiesel is surprisingly a highly efficient scrubbing liquid by means of which the aromatic hydrocarbons benzene, toluene, m-, p-, o-xylene and ethylbenzene can be removed. Biodiesel is also inexpensive, able to be handled without problems and additionally has an improved CO₂ balance.

In addition to the absorption of the BTEX components, the proportion of the polycyclic aromatic hydrocarbon naphthalene is significantly reduced. In a process as described in WO 2009/003 644 A1, the naphthalene concentration can be reduced from an initial proportion of typically up to 2 g/standard m³ (gram per standard cubic meter) at conventional process parameters to a concentration of from 100 to 150 mg/standard m³ (milligram per standard cubic meter). At comparable operating parameters, significantly higher values in the range from 200 to 300 mg/standard m³ are obtained in the case of a conventional scrubbing liquid based on mineral oil or tar oil since these have, even in the fresh state, a considerable residual concentration of naphthalene.

The present invention is concerned with the object of providing an improved process for regenerating a scrubbing liquid which is provided for a gas scrub and is enriched in aromatic hydrocarbons in order to make a more efficient gas scrub possible. In addition, regeneration arrangements which make it possible to carry out the process of the invention are to be provided.

To achieve the object, the invention provides a process as claimed in claim 1 and apparatuses as claimed in the ancilliary claims 11 and 12.

According to the process of the invention for regenerating a scrubbing liquid which is provided for a gas scrub and is enriched in aromatic hydrocarbons, the scrubbing liquid which is enriched in aromatic hydrocarbons is firstly brought into contact with steam in a first regeneration stage of the regeneration column, as a result of which the aromatic hydrocarbons are partly removed from the scrubbing liquid. The scrubbing liquid which has been purified in the first regeneration stage is then divided into a first stream and a second stream, with the second stream being discharged as purified scrubbing liquid for a gas scrub. The handling of the second stream corresponds essentially to the process known from the prior art. The scrubbing liquid is purified in the first regeneration stage to such an extent that it is once again suitable for effective scrubbing-out of aromatic hydrocarbons, in particular for a BTEX scrub.

Owing to the physical equilibria during the regeneration, residues of aromatic hydrocarbons always remain in the purified scrubbing liquid. However, a major part of the various aromatic hydrocarbons is removed in the first regeneration stage to such an extent that these impurities can subsequently once again be removed effectively from an offgas or process gas, for example coke oven gas, by means of the scrubbing liquid.

In view of this background, the invention is based on the recognition that the removal of individual aromatic hydrogen components can be insufficient when using only one regeneration stage. Thus, for example, in the purification of coke oven gas, the BTEX components benzene, toluene, m-, p-, o-xylene and ethylbenzene can be largely removed in the first regeneration stage while the content of the polycyclic aromatic hydrocarbon naphthalene remains comparatively high. In the case of the known processes for purifying coke oven gas, there is therefore a need to reduce the naphthalene content further. In addition to the health-endangering and environmentally hazardous properties of naphthalene, it can also form deposits in the piping system downstream of the BTEX scrub, as a result of which the corresponding lines are subjected to fouling or can even become blocked.

In order to be able to remove a further component, in particular naphthalene, with greater efficiency, the present invention teaches division of the scrubbing liquid into the first stream and the second stream, with the first stream being fed for the purpose of further regeneration to a second regeneration stage of the regeneration column in which the concentration of aromatic hydrocarbons is reduced further compared to the concentration in the second stream by contact with steam. For this purpose, a stream of steam which is conveyed firstly through the second regeneration stage and subsequently through the first regeneration stage is used according to the invention. Preference is given to the entire steam provided for the regeneration process being conveyed firstly through the second regeneration stage and subsequently through the first regeneration stage. The further regeneration in the second regeneration stage provides, in the form of the first stream, a more highly stripped scrubbing liquid which is particularly suitable for a fine scrub of a process gas or offgas from which aromatic hydrocarbons have been removed to a certain extent beforehand.

An important part of the present invention is the division of the scrubbing liquid purified in the first regeneration stage into the first stream and the second stream, with the second stream usually being larger than the first stream. The second stream, which then represents the major part of the purified scrubbing liquid, is suitable for efficient removal of the BTEX components. Only the usually smaller part of the first stream is fed to an additional regeneration in order then to be able to remove residues which have not previously been sufficiently removed in a multistage gas scrub, for example naphthalene. The highly stripped stream taken off from the second regeneration stage can also be referred to as ultra lean oil.

Since only a substream of the scrubbing medium regenerated in the first regeneration stage is brought into contact with the steam in the second regeneration stage, the steam still has its maximum temperature and the proportion of aromatic hydrocarbons has been reduced beforehand in the gas scrubber stage, remaining residues of aromatic hydrocarbons, for example naphthalene, can be effectively removed in the second regeneration stage.

Various scrubbing liquids in the form of scrubbing oils are possible for carrying out the process of the invention. Apart from conventional scrubbing liquids based on mineral oil or tar oil, biodiesel, in particular, is also possible as scrubbing liquid. With regard to the conventional scrubbing liquids, it has to be taken into account that these can have, even in the fresh state, a considerable residual concentration of aromatic hydrocarbons, in particular naphthalene. The two-stage regeneration of the first stream of the scrubbing liquid, as provided according to the invention, also makes it possible to remove the naphthalene originally present in the fresh scrubbing liquid, so that the scrubbing process according to the invention makes it possible to provide a substream of the scrubbing liquid in the form of the first stream which has a purity superior to that of the fresh scrubbing liquid. When fresh scrubbing liquid based on mineral oil or tar oil is fed in while the process is running, this is firstly diluted by'the circulated scrubbing oil with even the naphthalene originally present in the scrubbing liquid introduced being gradually removed when the scrubbing liquid is conveyed as first stream through the second regeneration stage.

The steam fed in for the purpose of regeneration is preferably superheated steam having a temperature of more than 150° C. After passing through the first regeneration stage, a scrubbing liquid which has been used beforehand for the BTEX scrub has only small proportions of BTEX components. The second stream can therefore be reused, without further treatment or modification of the scrubbing liquid, for the BTEX scrub, although the temperature suitable for this purpose usually has to be set.

The division of the scrubbing liquid which has been purified in the first regeneration stage can be effected either inside or outside the regeneration column.

In a first variant of the process of the invention, the entire scrubbing liquid purified in the first regeneration stage is collected in a bottom section of the first regeneration stage, introduced into a line system and divided in the line system into the first stream and the second stream. For this purpose, the line system advantageously has a pump and a branch leading to the second regeneration stage, through which the first stream is conveyed. The usually larger second stream can, for the purposes of the invention, be fed under level regulation and after cooling back to the BTEX scrub.

The usually smaller first stream is particularly preferably pressurized by means of the pump, for example a hot oil pump, and sprayed via a spray distributor into the second regeneration stage. Even at a low throughput, the cross-sectional area of the second regeneration stage is optimally utilized by means of the spraying, so that a uniform distribution and thus efficient utilization of the cross section of the second regeneration stage and also the internals usually provided therein in the form of packing is possible. The contact with the introduced steam makes effective removal of remaining hydrocarbon components, in particular naphthalene, possible. Preference is given to the entire steam provided for regeneration firstly being passed through the second regeneration stage and then through the first regeneration stage. However, it is in principle also possible for part of the steam to be introduced between the second regeneration stage and the first regeneration stage.

The first stream which has been highly stripped in the second regeneration stage is preferably taken off under level regulation from a lower column bottom of the regeneration column by means of a pump and provided for the gas scrub. As indicated above, the highly stripped first stream is, in particular, suitable for a downstream fine scrub in a multistage gas scrub.

In the above-described variant of the process in which the entire scrubbing liquid is collected and discharged after the first regeneration stage, level regulation is possible at the first regeneration stage, so that process fluctuations can be eliminated and, as a result, the risk of a safety shutdown in operation is also avoided. Since the entire scrubbing liquid is firstly transferred into the line system, the first stream can also be lightly pressurized and then sprayed, as a result of which effective utilization of the cross section of the second regeneration stage and in particular a packing surface which has been made available is obtained.

In an alternative variant of the process of the invention, a division of the scrubbing liquid purified in the first regeneration stage is carried out inside the regeneration column, with the first stream being conveyed directly, i.e. without leaving the regeneration column, into the second regeneration stage and the second stream being taken off from the first regeneration column below the first regeneration stage. For this purpose, the scrubbing liquid can, in particular, be collected by a collection facility in the first regeneration stage, with the second stream being taken off under flow regulation via a pump from the collection facility. The excess of scrubbing liquid builds up and flows over an overflow, for example in the form of a discharge weir, into a lower column section comprising the second regeneration stage.

The distribution of the scrubbing liquid can, in particular, be effected by means of a channel distributor designed for small throughputs. In the second regeneration stage, too, a relatively uniform distribution of the scrubbing liquid can be effected by the channel distributor. The further purification of the first stream and provision of it as a highly stripped scrubbing liquid are carried out as per the first process variant.

The above-described second process variant is distinguished by a smaller outlay in terms of construction and apparatus and also a smaller column height. To avoid dry running of the pump connected to the first regeneration stage, it advantageously has a fill level shutdown. Flooding of the lower column section in the case of a fault can be avoided by means of a shutdown device on a supply pump by means of which the scrubbing liquid is introduced into the first regeneration stage.

As indicated above, biodiesel can also be used as scrubbing liquid instead of a conventional scrubbing oil based on mineral oil or tar oil. The biodiesel is obtained from vegetable oils. Typical starting materials are, for example, rapeseed oil, palm oil, sunflower oil and soybean oil, depending on local circumstances, from which the corresponding methyl esters are formed. Rapeseed oil methyl ester (RME) is particularly suitable for the purposes of the invention; this can be produced in large quantities in regions having a temperate climate and is commercially available.

The composition and the chemical and physical properties of biodiesel are described, for example, in the standards DIN EN14214 (November 2003) and ASTM D 6751-07A. The standards mentioned relate to the use of biodiesel as fuel. Against this background, variants of biodiesel which can deviate to a certain extent from the abovementioned standards can also be used in addition to the standardized types of biodiesel for use as scrubbing liquid for the absorption of aromatic hydrocarbons.

The invention will be illustrated below with the aid of a drawing depicting only one working example. The figures show:

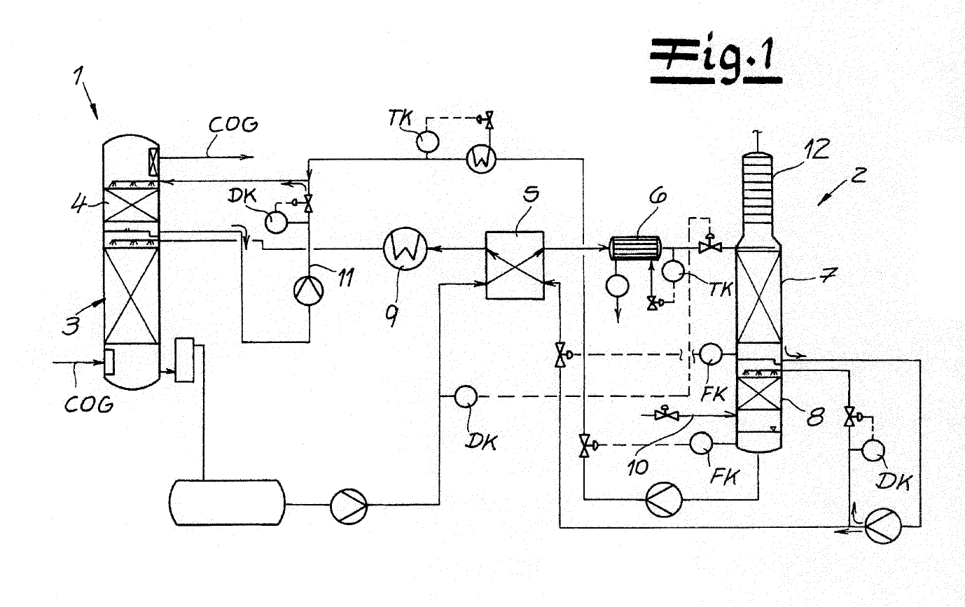

FIG. 1 a schematic, depiction of an apparatus for removing aromatic hydrocarbons, in which a scrubbing liquid is circulated,

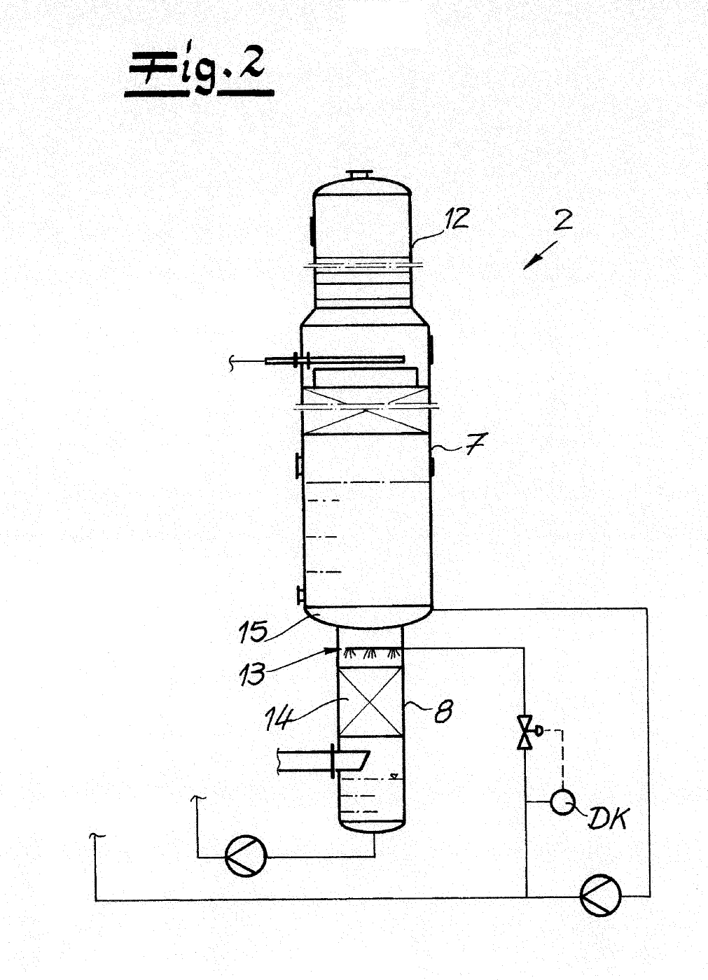

FIG. 2 a detailed view of a regeneration column as per FIG. 1,

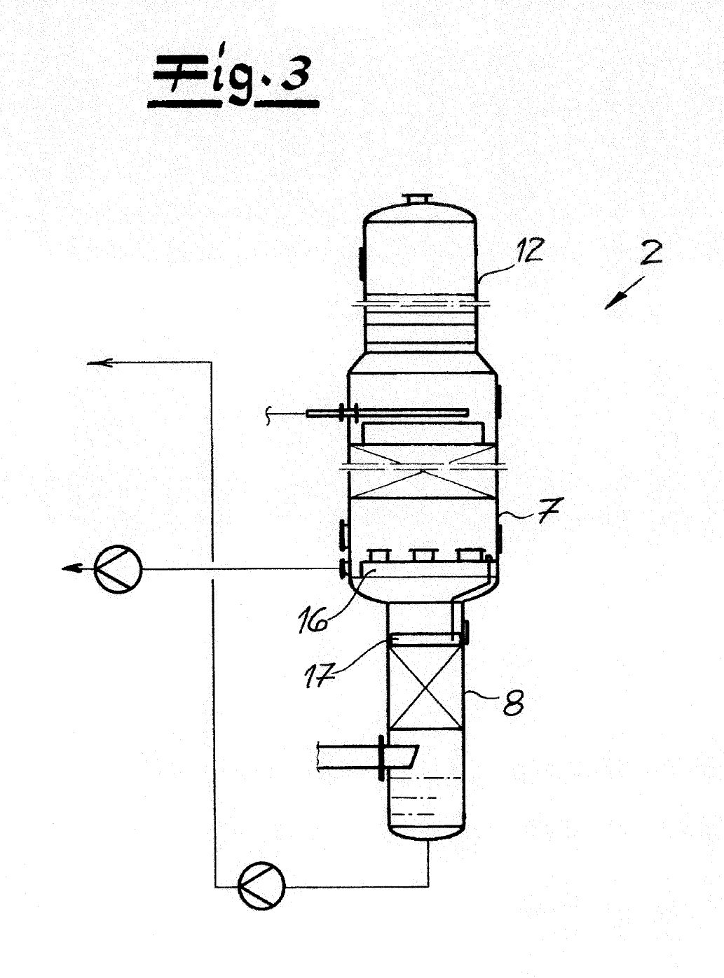

FIG. 3 an alternative embodiment of the regeneration column.

Important parts of the plant for removing aromatic hydrocarbons from a coke oven gas COG are, as shown in the depicted working example, a gas scrubbing column 1 and a regeneration column 2. The coke oven gas COG is introduced via a freed line into a lower region of the gas scrubbing column 1 and flows through the gas scrubbing column 1 in a vertical direction, being brought into contact with, for example, biodiesel as scrubbing liquid, as a result of which aromatic hydrocarbons are absorbed by the scrubbing liquid and thus separated off from the coke oven gas COG. The purified coke oven gas COG is then discharged through a discharge line in an upper region of the gas scrubbing column 1.

A first gas scrubbing stage 3 and, above that, a second gas scrubbing stage 4 are provided inside the gas scrubbing column.

The scrubbing liquid enriched in aromatic hydrocarbons is taken off from the bottom of the first gas scrubbing stage 3, i.e. from the bottom of the gas scrubbing column 1, and fed to the regeneration column 2

In order to make efficient removal of the aromatic hydrocarbons benzene, toluene, m-, p-, o-xylene and ethylbenzene (BTEX) possible in the first gas scrubbing stage 3, a temperature slightly above the gas entry temperature of the coke oven gas COG is preferably set in the case of biodiesel as scrubbing liquid in order to avoid condensation of the water present therein. The temperature relates to a substream (second substream) of the biodiesel which is, after regeneration, introduced directly into the first gas scrubbing stage 3.

In order to be able to separate the aromatic hydrocarbons from the scrubbing liquid in the regeneration column 2, the temperature of the scrubbing liquid is increased, for which purpose the scrubbing liquid taken off from the first gas scrubbing stage 3 is firstly conveyed through a heat exchanger 5 and then through a heating device 6. To regulate the temperature and streams, sensors for throughput control DK and for temperature control TK are provided in the line system. In addition, the fill levels in the regeneration column 2 can also be checked by means of sensors of a fill level control FK.

The entire scrubbing liquid is then introduced into a first regeneration stage 7 at a middle part of the regeneration column 2, with the scrubbing liquid in the first regeneration stage 7 having a temperature of from about 170° C. to 190° C. The temperature range indicated is above the boiling point of the BTEX components, so that these are released from the scrubbing liquid. Driving-off of the crude benzene by means of steam, in particular superheated steam having a temperature of more than 150° C., is particularly effective. Particular preference is given to a stripping temperature of from about 180° C. to 190° C.; even biodiesel as scrubbing liquid is not vaporized or decomposed to an appreciable extent at such a temperature.

The scrubbing liquid purified in the first regeneration stage 7 is subsequently divided into a first stream and a second stream. In the working example depicted (cf. FIG. 2), the scrubbing liquid is discharged at the bottom of the first regeneration stage 7 and divided outside the regeneration column 2 into the first stream and the second stream, and the first stream is fed to a second regeneration stage 8 for further regeneration while the second stream is, after setting of a suitable temperature by means of the heat exchanger 5 and a cooler 9, reintroduced into the first gas scrubbing stage 3 for removal of the BTEX components.

In a modification of the working example depicted, a division into the first stream and the second stream can also be effected at the bottom of the first regeneration stage 7 by only the second stream being discharged from the regeneration column 2 while the first stream goes directly into the second regeneration stage 8 for further purification (cf. FIG. 3).

As indicated above, regeneration is effected by means of steam which is introduced through a steam feed line 10 into the second regeneration stage 8 in a lower region of the regeneration column 2. Since all of the steam is brought into contact only with the first stream of the total scrubbing liquid, this proportion of the scrubbing liquid has already been largely purified and the steam still has its original temperature, additional purification of the scrubbing liquid can be achieved in the second regeneration stage 8, with, in particular, naphthalene being removed efficiently.

From the bottom of the second regeneration stage 8, i.e. from the bottom of the regeneration column 2, the more highly stripped first stream is fed to the second gas scrubbing stage 4 and mixed with a substream of the scrubbing liquid which is conveyed in a separate circuit 11 at the second gas scrubbing stage 4.

However, only part of the scrubbing liquid introduced is collected and circulated in the second gas scrubbing stage 4, while a further part goes into the first gas scrubbing stage 3 located underneath. The amount of the scrubbing liquid transferred from the second gas scrubbing stage 4 into the first gas scrubbing stage 1 corresponds to the substream of the regenerated scrubbing liquid which is fed in a highly stripped state to the second gas scrubbing stage 4.

As a result of such an open circuit at the second gas scrubbing stage 4, accumulation of naphthalene is avoided by discharge of enriched scrubbing liquid into the first gas scrubbing stage 3 and the corresponding addition of highly stripped scrubbing liquid.

The BTEX components driven off from the scrubbing liquid and the naphthalene driven off from the scrubbing liquid leave the regeneration column 2 at the top and can be recovered and utilized in a manner known per se. In FIG. 1, a rectification section 12 having a plurality of trays is provided for this purpose.

The improved removal of naphthalene from the coke oven gas COG compared to the prior art makes it possible to prevent troublesome deposits in the downstream line system.

The process parameters in the first gas scrubbing stage 3 are set so that the BTEX components can be effectively scrubbed out, while the parameters in the second gas scrubbing stage 4 are optimized for the removal of naphthalene. Owing to the different, in particular temperature-dependent equilibria, a higher temperature of the scrubbing liquid is preferably provided for the removal of naphthalene in the second gas scrubbing stage 4 than in the first gas scrubbing stage 3.

Of course, a (partial) replacement of the scrubbing liquid or a topping-up can be provided at a suitable place (not shown), even during operation.

FIG. 2 shows a detail view of a regeneration column 2 as per FIG. 1, in which the division into the first stream and the second stream is carried out outside the regeneration column 2. Since the total scrubbing liquid is firstly taken off and conveyed by means of a pump, the first stream can be sprayed by means of a spray distributor 13 into the second regeneration stage 8, by means of which a particularly uniform distribution over a packing 14 within the second regeneration stage 8 is achieved. In the embodiment shown in FIG. 2, a bottom section 15 in which the entire scrubbing liquid purified in the first regeneration stage 7 is firstly discharged from the regeneration column 2 is provided at the bottom of the first regeneration stage 7.

FIG. 3 shows a variant of the regeneration column 2, in which the division into the first stream and the second stream is carried out inside the regeneration column 2. A collection facility 16 which has an overflow is provided at the bottom of the first regeneration stage. While the second stream is taken off from the collection facility 16, the first stream flows over the overflow into the second regeneration stage 8. Within the second regeneration stage 8, there is a channel distributor 17 which allows relatively uniform distribution of the first substream of the scrubbing liquid, even though a uniform distribution can be achieved by spraying in an embodiment as per FIG. 2. However, compared to the embodiment shown in FIG. 2, a simplified line system which makes do without branches in the region of the regeneration column is obtained. Furthermore, a simpler, more compact column design is also obtained.

1. A method for regenerating a scrubbing liquid which is provided for a gas scrub and is enriched in aromatic hydrocarbons in a regeneration column, comprising:
the scrubbing liquid enriched in aromatic hydrocarbons is brought into contact with steam in a first regeneration stage of the regeneration column and the aromatic hydrocarbons are thereby partly removed from the scrubbing liquid,
the scrubbing liquid purified in the first regeneration stage is divided into a first stream and a second stream,
the second stream is discharged as purified scrubbing liquid for the gas scrub,
the first stream is, for the purpose of further regeneration, fed to a second regeneration stage of the regeneration column in which the concentration of aromatic hydrocarbons is reduced compared to the concentration in the second stream by contact with steam,
a stream of steam is firstly conveyed through the second regeneration stage and subsequently through the first regeneration stage and
the first stream is discharged as more highly stripped scrubbing liquid for the gas scrub.

2. The method of claim 1, wherein the second stream is larger than the first stream.

3. The method of claim 1, wherein the entire scrubbing liquid purified in the first regeneration stage is collected in a bottom section of the first regeneration stage, introduced into a line system and divided in the line system into the first stream and the second stream.

4. The method of claim 3, wherein the entire scrubbing liquid purified in the first regeneration stage is taken off by means of the line system from the regeneration column (2) and divided outside the regeneration column (2) into the first stream and the second stream.

5. The method of claim 3, wherein the first stream is conveyed by means of a pump and sprayed into the second regeneration stage.

6. The method of claim 1, wherein the scrubbing liquid purified in the first regeneration stage is divided inside the regeneration column into the first stream and the second stream, with the first stream being conveyed directly into the second regeneration stage and the second stream being taken off from the regeneration column.

7. The method of claim 6, wherein the division into the first stream and the second stream is effected at an overflow of an offtake tray or a bottom section of the first regeneration stage.

8. The method of claim 6, wherein the first stream is distributed by means of a channel distributor and introduced into the second regeneration stage.

9. The method of claim 1, wherein biodiesel is used as scrubbing liquid.

10. The method of claim 6, wherein the first stream is fed to a first gas scrubbing stage and brought into contact with a gas containing aromatic hydrocarbons in order to separate off the aromatic hydrocarbons and the gas which has been purified in the first gas scrubbing stage is fed to a second gas scrubbing stage in which it is brought into the more highly stripped first stream to effect further purification.

11. The method of claim 10, wherein the first stream is mixed at the second gas scrubbing stage with a third stream circulated there and introduced into the second gas scrubbing stage and a stream of scrubbing liquid which corresponds to the first stream fed in is transferred from the second gas scrubbing stage into the first gas scrubbing stage.

12. A regeneration apparatus for regenerating a scrubbing liquid for a gas scrub, which scrubbing liquid is enriched in aromatic hydrocarbons in a regeneration column, comprising:
a regeneration column which has a first regeneration stage and a second regeneration stage arranged underneath the first regeneration stage and a rectification section above the first regeneration stage, a steam feed line connected in the lower region of the regeneration column and a line system for purified scrubbing liquid connected to a collection facility of the first regeneration stage, wherein the collection facility is configured and arranged in such a way that it allows steam to flow from the second regeneration stage to the first regeneration stage, the collection facility is provided as a bottom section for collecting the entire scrubbing liquid purified in the first regeneration stage and the line system has at least one pump and a branch leading to the second regeneration stage.

13. A regeneration apparatus for regenerating a scrubbing liquid for a gas scrub, which scrubbing liquid is enriched in aromatic hydrocarbons in a regeneration column, comprising:
a regeneration column which has a first regeneration stage and a second regeneration stage arranged underneath the first regeneration stage and a rectification section above the first regeneration stage, a steam feed line connected in the lower region of the regeneration column and a line system for purified scrubbing liquid connected to a collection facility of the first regeneration stage, wherein the collection facility is configured and arranged in such a way that it allows steam to flow from the second regeneration stage to the first regeneration stage and effects division of the scrubbing liquid purified in the first regeneration stage.
